(19) United States
(12) Patent Application Publication
(10) Pub. No.: US 2002/0047366 A1
(43) Pub. Date: Apr. 25, 2002

(54) Device for connecting an electric motor

(75) Inventors: Uwe Allendorf, Hauneck (DE); Jurgen Zoll, Heringen (DE)

Correspondence Address: COHEN, PONTANI, LIEBERMAN & PAVANE, 551 Fifth Avenue, Suite 1210, New York, NY, 10176, US

(73) Assignee: Mannesmann VDO AG

(21) Appl. No.: 09/849,645

(22) Filed: May 4, 2001

(30) Foreign Application Priority Data
May 5, 2000 (DE) 100 21 949.7

(51) Int. Cl. H02K 11/00

(52) U.S. Cl. 310/72; 310/68 R

(57) ABSTRACT

A suppressor for a device for connecting an electric motor has a varistor and a capacitor connected in parallel for providing suppression for the electric motor. The suppressor has particularly small dimensions compared with a capacitor exhibiting a comparable suppression strength. For the purposes of providing suppression for electric motors used for fuel pumps, the dimensions of the suppressor are fundamentally independent of its power and the level of design complexity required for mounting suppressors on the electric motor with a different power is particularly low.

### BACKGROUND OF THE INVENTION

1. Field of the Invention

The present invention relates to a connection device for connecting an electric motor for driving a fuel pump, the device having two electrical conductors leading to the electric motor and having a suppressor arranged between the conductors.

2. Description of the Related Art

Devices for connecting electric motors used for driving fuel pumps in motor vehicles usually have a capacitor as a suppressor. The capacitor suppresses the formation of electromagnetic interference fields in the electric motor up to a prescribed degree, depending on its capacitance. Many new electronic components used in motor vehicles, such as a navigation instruments, are sensitive to electromagnetic interference and require particularly reliable suppression in the electric motor.

A capacitor of appropriate size could be used to provide the suppression. However, this causes space problems and also makes it difficult to accommodate the suppressor particularly when the electric motor is used for driving a fuel pump. In addition, the size of capacitors is dependent on the capacitance of the capacitor. Accordingly, the electric motor requires receptacles which are dimensioned on the basis of the amount of suppression envisaged for a particular application.

### SUMMARY OF THE INVENTION

The object of the present invention is to provide a connection device for connecting an electric motor used for fuel delivery in a motor vehicle such that the suppressor is arranged on the electric motor with particularly little complexity of design.

The object of the present invention is met by providing a connection device with a suppressor having a capacitor and a varistor connected in parallel.

The device according to the present invention allows the use of suppressors matched to the suppression envisaged for a particular application. Since a suppressor with a capacitor and a varistor is approximately two thirds smaller than a comparable suppressor having only a capacitor with a large capacitance, the suppressor according to the present invention may be designed to have particularly small dimensions while reliably suppressing the electromagnetic interference fields. By way of example, a suppressor according to the present invention having a suppression which is equivalent to a suppressor having a capacitor having the capacitance 4.7 μF is the size of a 1.5 μF capacitor. The suppressor equivalent to a capacitor having the capacitance 4.7 μF may be used to provide sufficient suppression for an electric motor provided for use in a motor vehicle equipped with a navigation system, for example. The small dimensions of the suppressor with the varistor and capacitor allow it to be fixed to the electric motor with little complexity. Another advantage of the suppressor according to the present invention is that suppressors with a different power which are provided for suppression in low power electric motors are of approximately the same size. This allows the suppression strength to be varied without changing the size of the receptacle for the varistor on the electric motor.

In a further embodiment, the varistor may be formed as a disk-type varistor to facilitate the fixing of the suppressor to the electric motor.

To simplify mounting of the device according to the present invention on the electric motor, the suppressor may include a casing made of fuel resistant plastic. The fuel resistant plastic may, for example, be epoxy resin, POM or PPS. In this context, receptacles for fixing element may easily be provided in the plastic as well.

To further simplify mounting of the device according to the present invention, the casing may be integrally connected to the suppressor alone or together with inductors and regions of the electric motor which adjoin the latter. The integral connection may be produced by means of casting or injection molding, for example.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic sectional view of an electric motor, with a device according to the present invention;

FIG. 2 is a view of the device of FIG. 1 without a casing;

FIG. 3 is a view of the device of FIG. 1 encased in plastic; and

FIG. 4 is a schematic diagram showing the suppressor of the device in FIG. 2.

### DETAILED DESCRIPTION OF THE PRESENTLY PREFERRED EMBODIMENTS

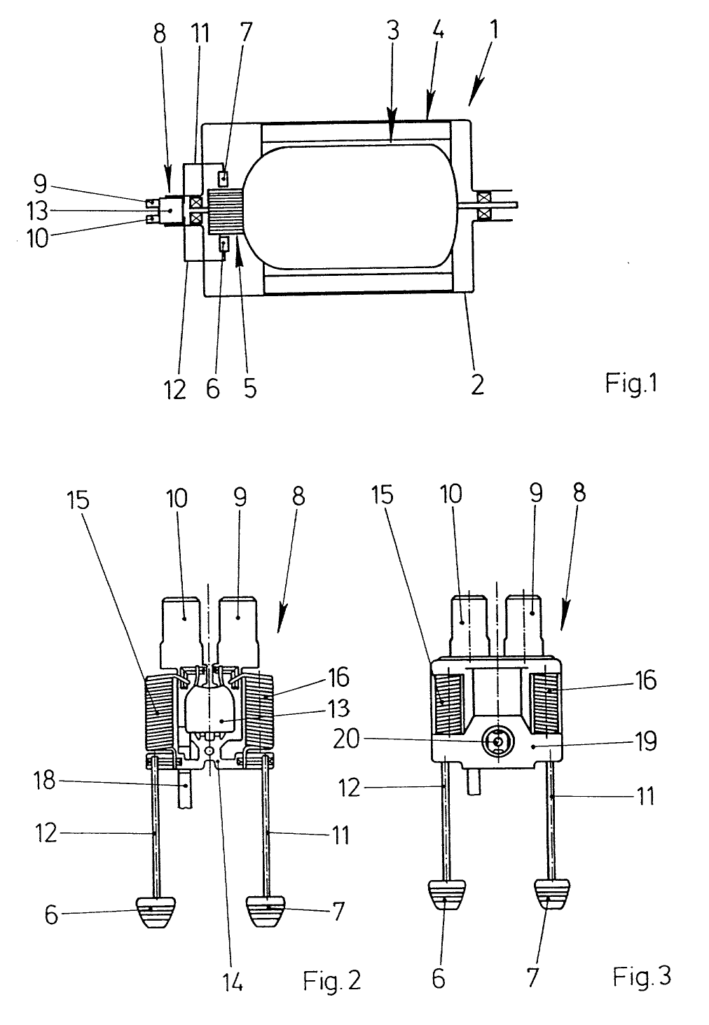

An electric motor 1 is shown in FIG. 1 with a rotor 3 mounted for rotation in a housing 2 and with a stator 4. An armature 5 is arranged for supplying the rotor 3 with electric current via carbon brushes 6, 7 which pass over the armature 5. The brushes 6, 7 of the armature are supplied with electric current by a device 8 having connection contacts 9, 10 and having connecting lines 11, 12 which lead to the carbon brushes 6, 7. A suppressor 13 is arranged between the connection contacts 9, 10. Plug contacts (not shown) of a power supply may be connected to the connection contacts 9, 10. The electric motor 1 is arranged for driving a fuel pump in a motor vehicle and has fuel flowing through it.

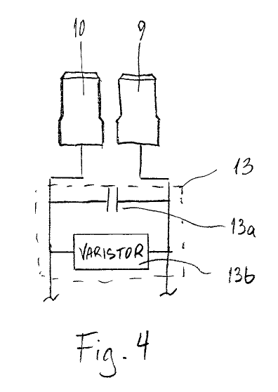

FIG. 2 is a greatly magnified illustration of the device 8 from FIG. 1. The connection contacts 9, 10, the connecting lines 11, 12 and the suppressor 13 are fixed to a support 14 made of an electrically non-conductive material. Respective inductors 15, 16 are arranged between the connection contacts 9, 10 and the connecting lines 11, 12. In addition, the device 8 has a ground spring 18. FIG. 4 shows that the suppressor 13 has a capacitor 13a with a varistor 13b connected in parallel, the varistor being in the form of a disk type varistor and being connected to the two connection contacts 9, 10.

FIG. 3 shows the device from FIG. 2 with a casing 19 made of fuel resistant plastic. The casing 19 completely surrounds the suppressor 13 which is shown in FIG. 2. The device 8 has a central recess 20 for allowing a fixing element to pass through. This allows the device 8 to be fixed to the electric motor 1 shown in FIG. 1. Since the suppressor 13 shown in FIG. 2 has a virtually constant size irrespective of its power, the device 8 can be matched to an envisaged suppression strength without any change in the position of the recess 20 or in the external dimensions of the device 8.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A device for connecting an electric motor, comprising:
two electrical conductors leading to the electric motor; and
a suppressor arranged between said two electrical conductors, wherein said suppressor includes a capacitor and a varistor connected in parallel.

2. The device of claim 1, wherein said varistor is a disk type varistor.

3. The device of claim 1, further comprising a casing made of fuel resistant plastic.

4. The device of claim 3, wherein said casing is integrally connected with said suppressor.

5. The device of claim 3, further comprising inductors respectively connected to said two electrical conductors, wherein said casing is integrally connected with said suppressor and with said inductors.

6. A combination including an electric motor and a device for connecting the electric motor, said device comprising:
two electrical conductors leading to the electric motor;
a suppressor arranged between said two electrical conductors, wherein said suppressor includes a capacitor and a varistor connected in parallel;
a casing made of fuel resistant plastic; and
inductors respectively connected to said two electrical conductors, wherein said casing is integrally connected with said suppressor, said inductors and regions of said electric motor which adjoin said inductors.
